(19) United States
(12) Patent Application Publication
(10) Pub. No.: US 2017/0267012 A1
(43) Pub. Date: Sep. 21, 2017

(54) CASCADING SURPRISE DOORWAY DISPLAY ARTICLE WITH SOUND PLAYBACK

(71) Applicant: DOORWAY CELEBRATIONS, LLC, BUFFALO GROVE, IL (US)

(72) Inventor: SCOTT KRIEMAN, BUFFALO GROVE, IL (US)

(21) Appl. No.: 15/139,159

(22) Filed: Apr. 26, 2016

Related U.S. Application Data
(60) Provisional application No. 62/308,756, filed on Mar. 15, 2016.

(51) Int. Cl. B42D 15/02; G09F 27/00; G09F 1/10; G09F 1/04; G09F 1/08

(52) U.S. Cl. CPC B42D 15/022; G09F 1/04; G09F 1/08; G09F 1/10; G09F 27/00; G09F 2027/002

(57) ABSTRACT

The present invention relates generally to a mounted display article, and more particularly to a multi-panel bulletin display mounted above a door frame that vertically unfolds or cascades in response to a trigger mechanism, the multi-panel bulletin display having cuts for receiving a removable greeting insert that has printed matter as well as a sound playback device that plays in response to the trigger mechanism.

### CROSS REFERENCE TO RELATED APPLICATIONS

This application claims priority benefit under 35 U.S.C. 119 to U.S. Provisional 62/308,756 filed Mar. 15, 2016, the entire contents of which are incorporated herein in their entirety.

### STATEMENT REGARDING FEDERALLY SPONSORED R&D

None

### NAMES OF PARTIES TO JOINT RESEARCH AGREEMENT

None

### REFERENCE TO SEQUENCE LISTING

None

### FIELD OF THE INVENTION

The present invention relates generally to a mounted display article, and more particularly to a multi-panel bulletin display mounted above a door frame that vertically unfolds or cascades in response to a trigger mechanism, the multi-panel bulletin display having cuts for various electronic and mechanical components, and/or for receiving a removable greeting insert that has printed matter as well as a sound playback device and moveable objects that play in response to the trigger mechanism.

### BACKGROUND OF THE INVENTION

The greeting card industry has evolved from simple paper cards to fanciful cards made from exotic paper to cards having recordable music that plays when a card is opened.

U.S. Pat. No. 9,189,977 and related patents disclose electronic greeting cards that include a greeting card with two or more interconnected panels in combination with a digital multimedia player device which includes an electronic display and an audio output, and circuitry which is operative to receive, store and play digital multimedia files and content.

U.S. Pat. No. 8,418,384 discloses an interactive greeting card operative to move between a first position wherein several interconnected panels are folded into a substantially flat position and a second position wherein the several interconnected panels are unfolded into a three-dimensional pop-up structure. Movement between the first and second positions may also control playback of digital audio, activation of one or more LED lights, or various other special effects.

U.S. Pat. 9,027,269 discloses an interactive electronic greeting card with pop up feature that includes a three-sided pocket or cavity which houses various electronic and mechanical components and a pop up element for confetti.

U.S. Pat. 9,009,998 discloses greeting cards with moving elements or devices which are operable to create motion in connection with some portion of the greeting card. The greeting card may include a multi-panel greeting card body or a three-dimensional foam greeting card body. At least one movable object is contained upon or within the greeting card body. A sound module having at least one pre-recorded digital audio file saved therein and a motor module are contained and concealed within the greeting card body.

U.S. Pat. No. 8,661,719 discloses an interactive greeting card that contains a multi-panel greeting card body with various electronic components contained and concealed therein. Upon opening the greeting card, spoken instructions may instruct the user to move an attached magnet from one area of the greeting card to another to initiate a surprise or various special effects such as sound and light.

U.S. Pat. No. 7,634,864 discloses a greeting card having an inner greeting card where a trigger is provided which is movable between a first position wherein the inner card is prevented from opening, and a second position wherein the card is allowed to move between the closed and open positions.

U.S. patent publication 20150135566 discloses hand-held greeting cards that have a pop-up 3D structure, e.g. a small house, that can have lighting and sound features.

However, none of the cards found in the prior art disclose mounting the card to a doorframe to be actuated when the door opens.

U.S. Pat. No. 8,596,331 discloses a mounting system for holding one or more affinity displays upon a window in an exceptionally stable manner. The apparatus comprises a drape that is capable of being wrapped around the edge or frame edge of a window, and the drape is also attached to a plurality of surface mounting components. The drape is further linked to the affinity display.

U.S. Pat. No. 4,052,805 discloses a vertical mounting system with adhesive vertical strips which can hang greeting cards received during an event, e.g. holiday or birthday.

U.S. Pat. No. 4,791,740 discloses a decorative display arch for mounting a banner and for mounting received greeting cards on a door frame.

U.S. Pat. No. 6,694,650 discloses a panel display having translucent pockets for displaying or dispensing flat paper or plastic items.

U.S. patent publication 20050061939 discloses a cardboard hanger for hanging items on a strung piece of wire or string.

Accordingly, none of the prior art documents found provide for a mounted display article, and more particularly to a multi-panel bulletin display mounted above a door frame that vertically unfolds or cascades in response to a trigger mechanism, the multi-panel bulletin display having cuts for receiving a removable greeting insert that has printed matter as well as a sound playback device that plays in response to the trigger mechanism.

### BRIEF SUMMARY OF THE INVENTION

Accordingly, the present inventive subject matter provides in one preferred embodiment a mounted display article, comprising: (i) a multi-panel bulletin display; (ii) a mounting device that removably attaches to a proximal edge of a first panel of the multi-panel bulletin display; (iii) a second panel of the multi-panel bulletin device connected to a distal edge of the first panel with a foldable binding, the second panel having die-cuts for receiving a removable greeting card insert; (iv) the removable greeting card insert comprising printed matter and a sound playback device; (v) a trigger mechanism connected to the second panel and activated by a motion of a user; wherein in response to an activated trigger mechanism, the second panel unfolds along the foldable binding from a first position to a second position where the first position and the second position are aligned in a vertical axis; and, wherein in response to the trigger mechanism, the sound playback device plays a pre-recorded message.

In another preferred embodiment, there is provided the mounted display article as disclosed and claimed herein, wherein the removable greeting card insert further comprises a light display.

In another preferred embodiment, there is provided the mounted display article as disclosed and claimed herein, wherein the removable greeting card insert further comprises a motorized movable object.

In another preferred embodiment, there is provided the mounted display article as disclosed and claimed herein, wherein the removable greeting card insert further comprises a circuit board connecting the sound playback device and a light display.

In another preferred embodiment, there is provided the mounted display article as disclosed and claimed herein, wherein the removable greeting card insert further comprises a circuit board connecting the sound playback device, a light display, and a motorized movable object.

In another preferred embodiment, there is provided the mounted display article as disclosed and claimed herein, wherein the trigger mechanism is selected from the group consisting of a pin and tether trigger device, a light sensor trigger device, and a motion sensor trigger device.

In another preferred embodiment, there is provided the mounted display article as disclosed and claimed herein, wherein the printed matter and the sound playback device have an event or holiday theme.

In another preferred embodiment, there is provided a method of displaying a multi-panel bulletin, comprising the steps of: (i) Mounting a multi-panel bulletin display to a wall or doorframe using a mounting device, the mounting device is removably attached to a proximal edge of a first panel of the multi-panel bulletin display, a second panel of the multi-panel bulletin device connected to a distal edge of the first panel with a foldable binding, the second panel having die-cuts for receiving a removable greeting card insert, the removable greeting card insert comprising printed matter and a sound playback device; and, (ii) Triggering the second panel to unfold along the foldable binding from a first position to a second position using a triggering mechanism connected to the second panel and activated by a motion of a user, where the first position and the second position are aligned in a vertical axis, and wherein triggering simultaneously plays a pre-recorded message using the sound playback device.

In another preferred embodiment, there is provided the method as disclosed and claimed herein, wherein the removable greeting card insert further comprises a light display and the step of triggering activates the light display.

In another preferred embodiment, there is provided the method as disclosed and claimed herein, wherein the removable greeting card insert further comprises a motorized movable object and the step of triggering activates the motorized movable object.

In another preferred embodiment, there is provided the method as disclosed and claimed herein, wherein the removable greeting card insert further comprises a circuit board connecting the sound playback device and a light display and the step of triggering simultaneously activates the sound playback device and the light display.

In another preferred embodiment, there is provided the method as disclosed and claimed herein, wherein the removable greeting card insert further comprises a circuit board connecting the sound playback device, a light display, and a motorized movable object and the step of triggering simultaneously activates the sound playback device, the light display, and the motorized movable display.

In another preferred embodiment, there is provided the method as disclosed and claimed herein, wherein the trigger mechanism is selected from the group consisting of a pin and tether trigger device, a light sensor trigger device, and a motion sensor trigger device.

In another preferred embodiment, there is provided the method as disclosed and claimed herein, wherein the printed matter and the sound playback device have an event or holiday theme.

These and other features and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE FIGURES

FIG. 1 illustrates an exemplary mounted display article having mounting holes, a first and second panel, a removable greeting card insert held in place by die-cuts in the second panel, and the removable greeting card insert having printed indicia, sound playback device (not shown) and light display.

FIG. 2 illustrates an exemplary mounting device with wall/doorframe mounting adhesive pads and hooks for inserting into the apertures of the first panel.

FIG. 3 illustrates an exemplary trigger mechanism and shows a pin and string device that is mounted adjacent the mounting device for the display article.

FIG. 4 illustrates an exemplary mounted display article having mounting holes, a first and second panel, a removable greeting card insert held in place by die-cuts in the second panel, and the removable greeting card insert having printed indicia, motorized moveable objects, sound playback device (not shown) and light display incorporated into the moveable object.

FIG. 5 illustrates an exemplary mounted display article having mounting holes, a first and second panel, a removable greeting card insert held in place by die-cuts in the second panel, and the removable greeting card insert having printed indicia, sound playback device (not shown) and light display.

FIG. 6 illustrates an exemplary wall-mounted display article showing a single panel embodiment having a removable greeting card insert where sound, lighting, and movable objects can be activated within the insert using a trigger mechanism that is not connected to a vertical axis dropping and unfolding of a multi-panel embodiment.

FIG. 7 illustrates an exemplary multi-panel bulletin board paper template showing die-cuts for the removable insert, a display window for the insert that has printed material, lighted devices, and/or moving objects, and the third panel as back-cover to enclose the electronics.

FIG. 8 is a front view of template and shows how the second panel folds up along second fold behind the template to enclose the electronics, leaving second panel to unfold away from the first panel along the first fold and cause the display window to be oriented to the front user facing view.

FIG. 9 illustrates front view of the template showing the second panel having die-cut windows where the electronic components can be mounted and extend from the back through to the user facing side of a second panel, and FIG. 9 shows angle die cuts for holding the removable insert.

FIG. 10 illustrates an exemplary electronics aspect of a mounted display article showing how the display window looks from the back exposing the electronics, and how the unfolding of the panels can be used to actuate the electronic components, e.g. lighting, sound, moving objects. FIG. 10 also shows a circuit of LED lights connected to an electronic module and a control module, as well as a rounded speaker of the integrated recordable sound playback device.

FIG. 11 illustrates a full-size embodiment of a mounted display article that unfolds for a celebrant and also provides a window display for a user's face.

FIG. 12 illustrates a medium size embodiment of a mounted display article, in this case a Santa mask, that unfolds for a celebrant and also provides a window display for a user's face.

FIG. 13 illustrates a medium size embodiment of a mounted display article, in this case a Santa border, that unfolds for a celebrant and also provides a window display with die cuts in the paper board which receives a removable insert.

FIG. 14 is a front view of template and shows a confetti/ribbon trough and how the second panel folds up along second fold behind the template to enclose the electronics, leaving second panel to unfold away from the first panel along the first fold and cause the display window to be oriented to the front user facing view, leaving the confetti/ribbon trough to empty its contents and add to the display.

FIG. 15A, 15B, 15C, and 15D are four views of one embodiment of a display article according to the present invention, and show another trigger means and a wall/moulding extension.

FIG. 16A and 16B are front and back views of a single panel embodiment of a display article.

FIG. 17A and 17B are before and after views of a two-panel door-mounted embodiment of a display article.

FIG. 18A, 18B, 18C, and 18D are four views of one embodiment of a display article mounted above a door frame and starting from a locked or closed position in 18A illustrates how it opens and is then viewed by the target of the greeting in FIG. 18D.

### DETAILED DESCRIPTION OF THE INVENTION

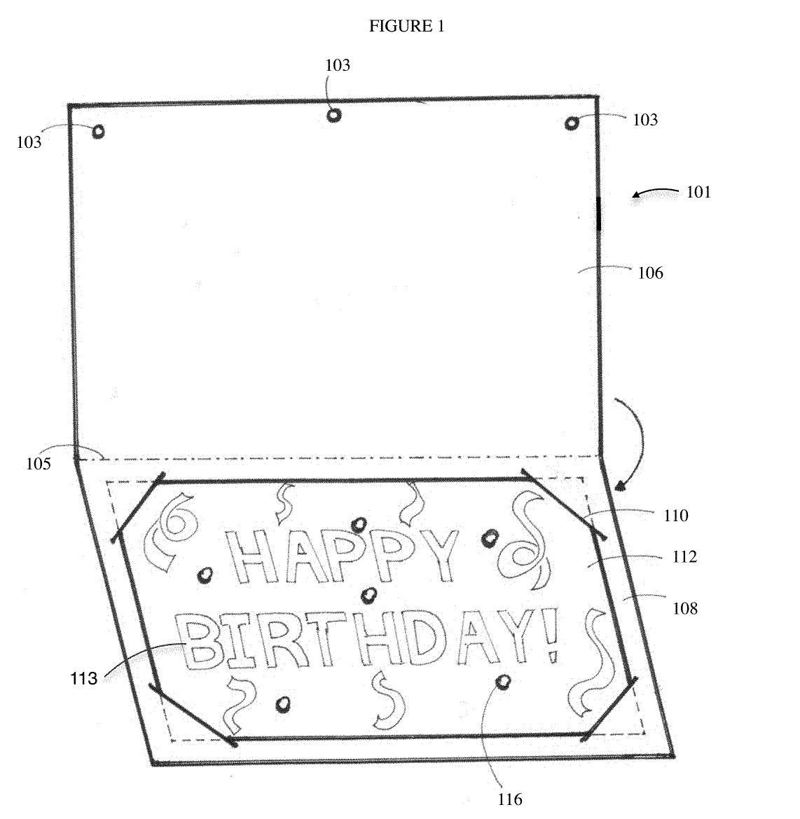

Referring now to the FIGURES, FIGS. 1, 4 and 5 show a mounted display article 101 having mounting holes 103, a first panel 106 and second panel 108, a removable greeting card insert 112 held in place by die-cuts 110 in the second panel, and the removable greeting card insert having printed indicia 113, sound playback device 114 (not shown) and LED light display 116.

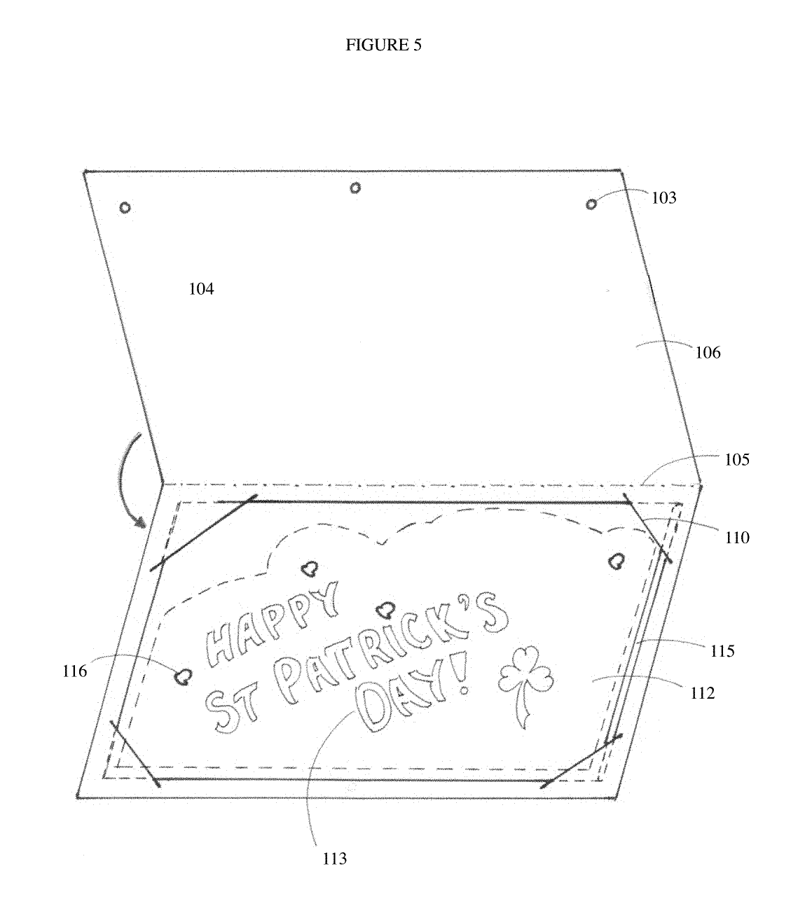

Various bulletin/card constructs can be used, as are known in the art and various materials such as paper, paperboard, cardboard, plastic, foam, or any other material or combination of materials may be used for the panels 106, 108 and the removable greeting card insert 112. The insert 112 may also be a printed graphic held within a protective sleeve 115 as shown in FIG. 5.

Sound playback device 114 includes standard electronic recording and playback devices. Thus, microphones and storage media contemplated. It is also contemplated that playback device 114 can include those accepting removable storage media, e.g. SD cards, or iPods, etc. thru a headphone jack. The sound playback device is mounted behind or within the main display/greeting panel and sound or music is broadcast for the person who is the target of the greeting. The sounds playback device is actuated either by the pulling of the pin or tab from the locking loop, by a switch located in the fold between two panels that is operated as the panels unfold, or using a motion sensor device. The sound playback device is battery operated, compact, and lightweight.

The LED light displays 116 are contemplated to be LED fixtures, and may include simple flashing light displays, or may incorporate more elaborate displays suggestive of motion within the insert. The LED lights are mounted behind or within the main display/greeting panel and the LEDs extend through the panel to provide a lighting display that is broadcast for the person who is the target of the greeting. The LEDs are actuated either by the pulling of the pin or tab from the locking loop, by a switch located in the fold between two panels that is operated as the panels unfold, or using a motion sensor device. The LEDs are battery operated and installed as a circuit on (rear face) or within the display panel.

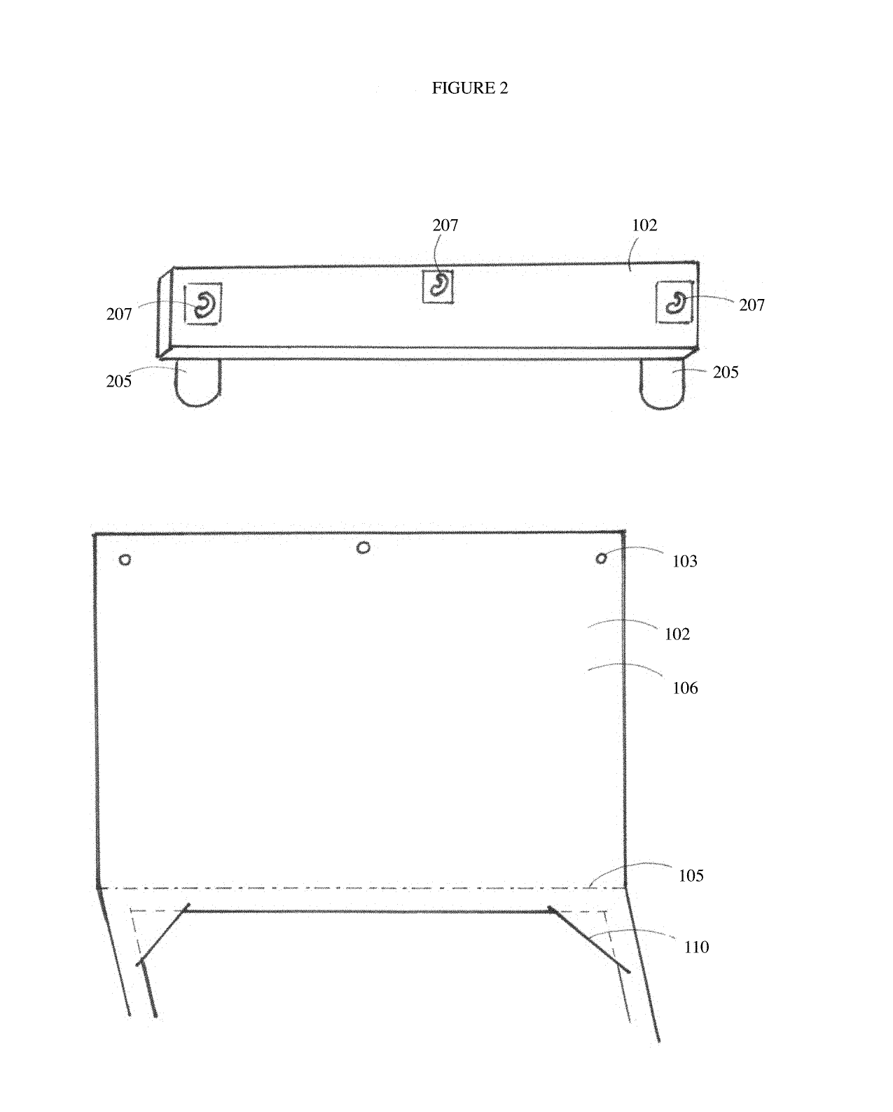

FIG. 2 illustrates an exemplary mounting device 102 with wall/doorframe mounting adhesive pads 205 and hooks 207 for inserting into the apertures 103 of the first panel 106.

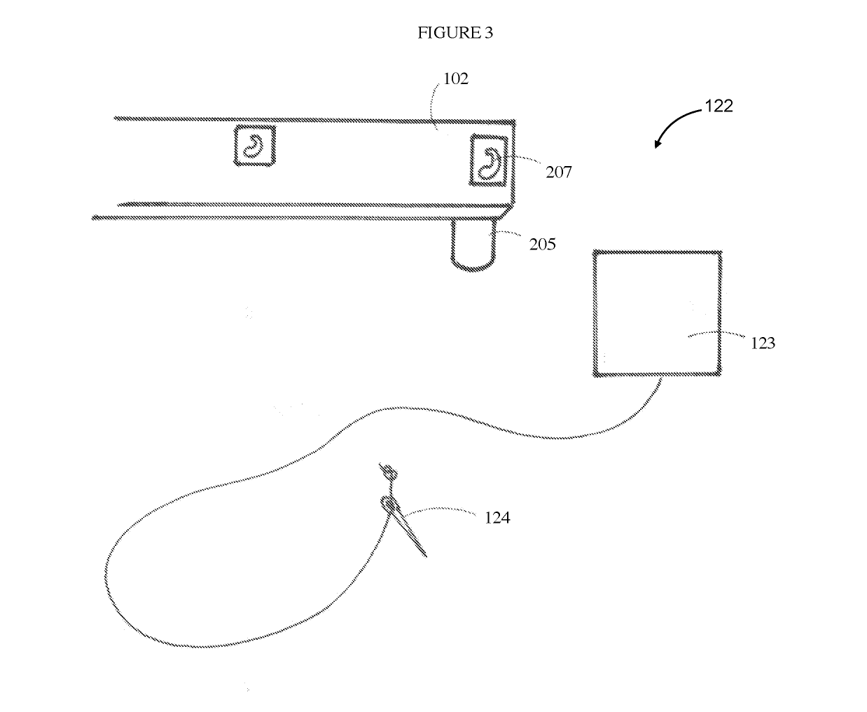

FIG. 3 illustrates an exemplary trigger mechanism 122 and shows a pin and tether/string device 124 that is mounted adjacent the mounting device 102 for the display article.

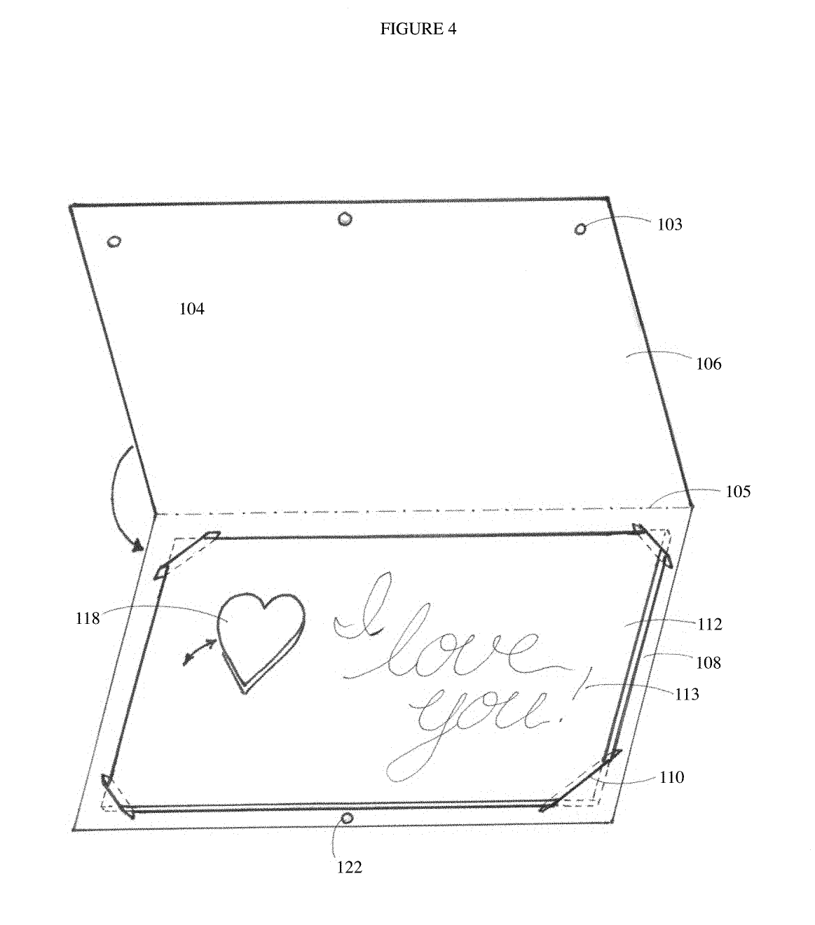

FIG. 4 illustrates another example of a mounted display article made from a two-panel embodiment 104 of the multi-panel bulletin display article and shows mounting holes 103 on the first panel 106, fold 105, connecting the first panel to the second panel 108. Second panel 108 has die cuts 110 for holding a removable insert 112 having printed indicia 113 and motorized moveable object 118.

FIG. 5 illustrates another example of a mounted display article made from a two-panel embodiment 104 of the multi-panel bulletin display article and shows mounting holes 103 on the first panel 106, fold 105, connecting the first panel to the second panel 108. Second panel 108 has die cuts 110 for holding a removable insert 112 having printed indicia 113 and motorized moveable object 118.

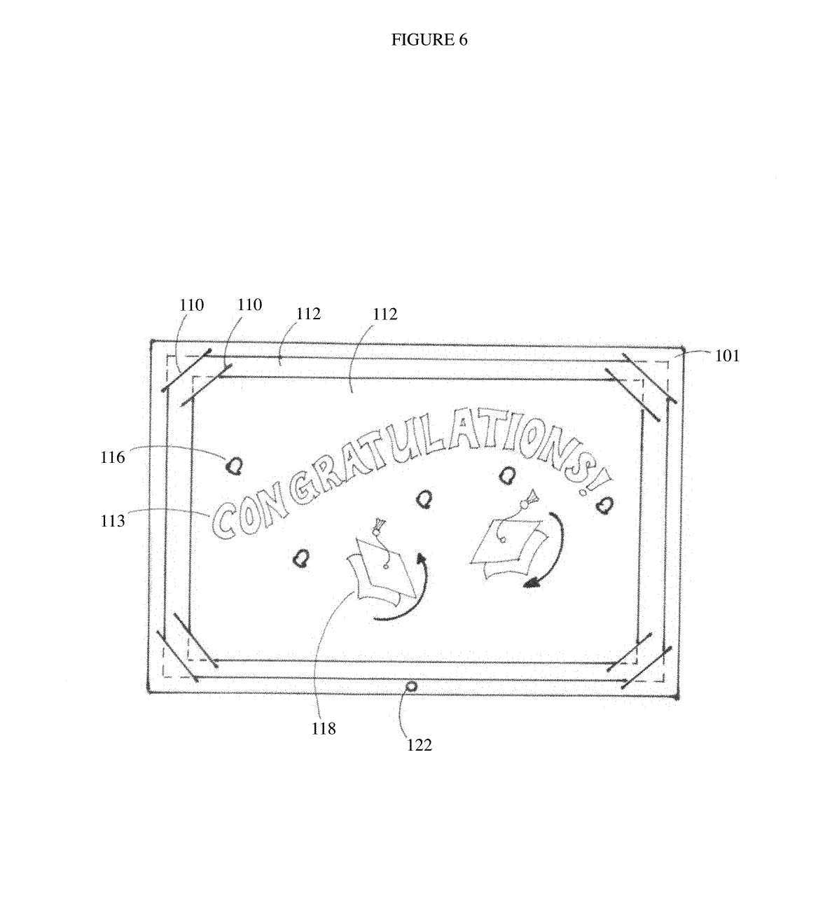

FIG. 6 illustrates an exemplary wall-mounted display article showing a single panel embodiment having a removable greeting card insert where sound, lighting, and movable objects can be activated within the insert using a trigger mechanism that is not connected to a vertical axis dropping and unfolding of a multi-panel embodiment. The sound, lighting, and moveable objects are actuated either by the pulling of the pin or tab from a locking loop (not shown), using a motion sensor device, or using a remote control (not shown).

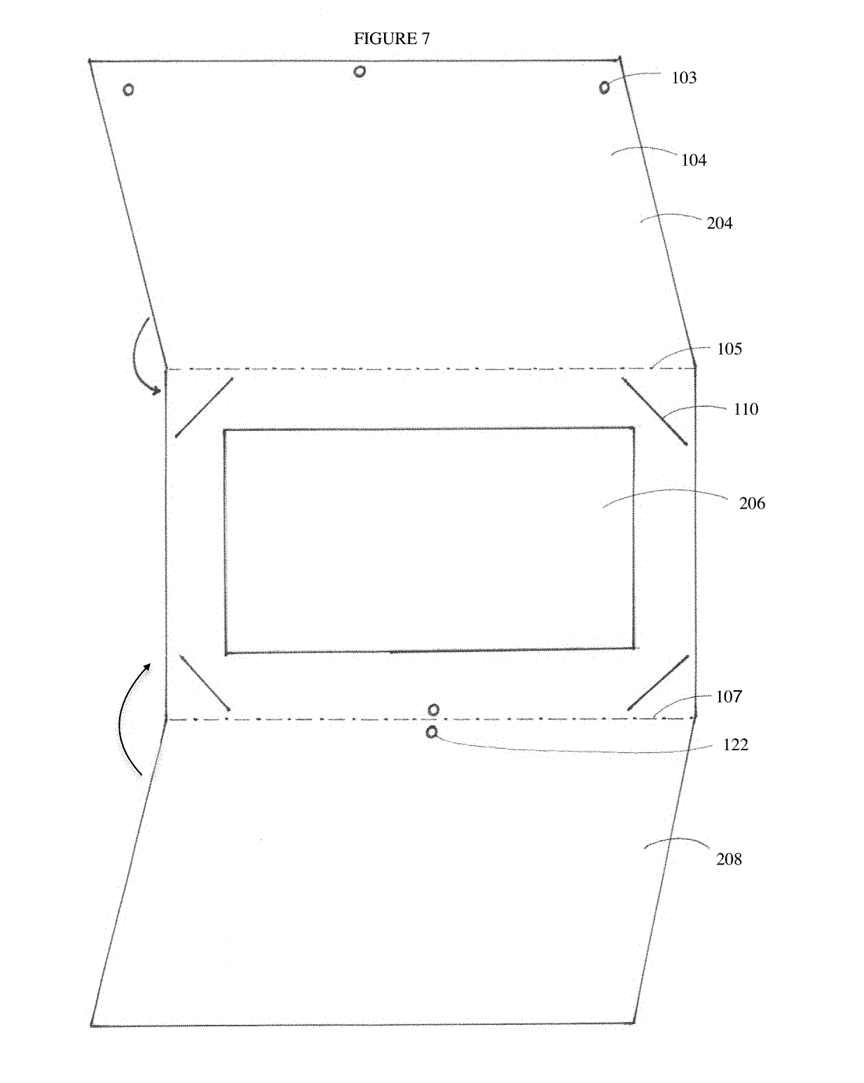

FIG. 7 illustrates an exemplary multi-panel bulletin board paper template 204 showing die-cuts 110 for the removable insert 112, a display window 206 for the printed material, lighted devices, and/or moving objects, and the third panel 208 as back-cover to enclose the electronics.

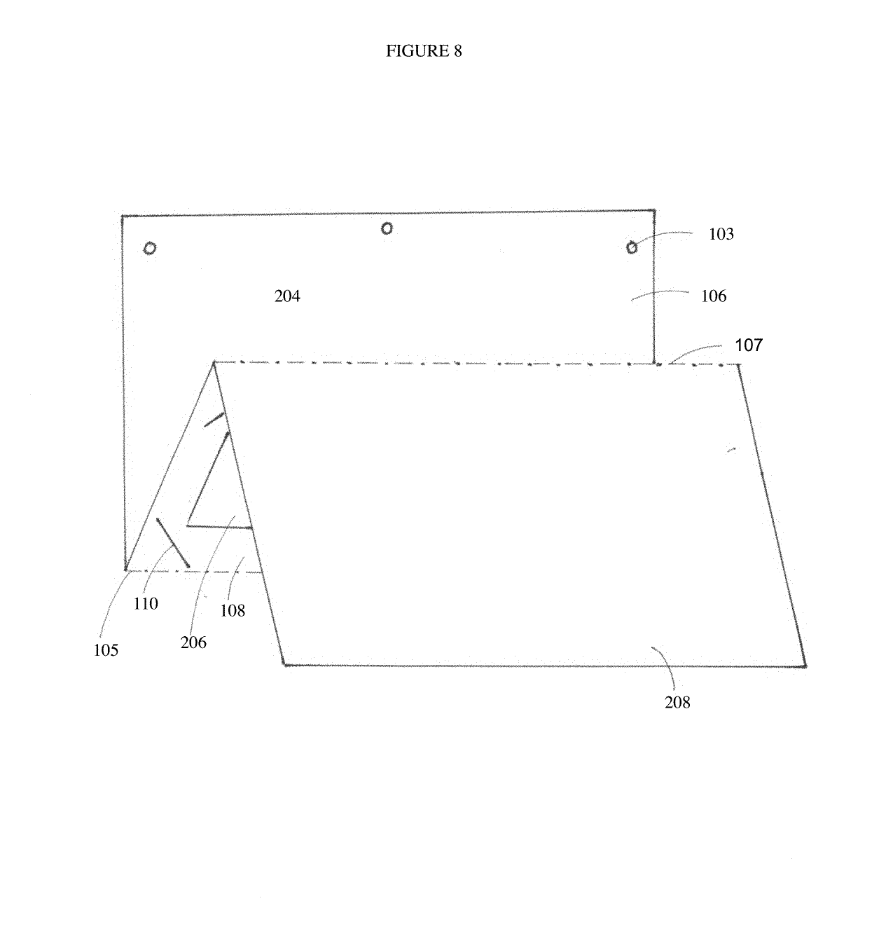

FIG. 8 illustrates a front view of template 204 and shows how panel 208 folds up along second fold 107 behind the template 204 to enclose the electronics (not shown), leaving second panel 108 to unfold away from panel 106 along (first) fold 105 and cause display window 206 to be oriented to the front view.

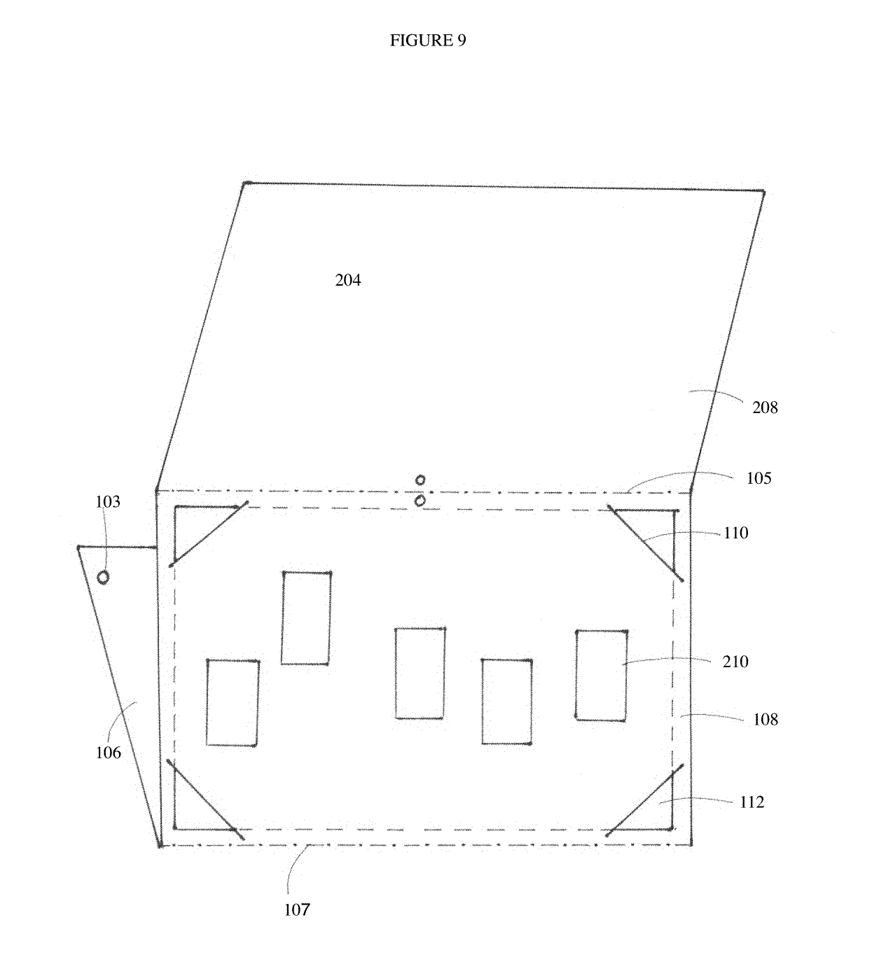

FIG. 9 illustrates a second panel 108 showing mounting windows 210 where the electronic components for sound 114, for lights 116, for moveable objects 118, electronics 120, motor housing 130, and motion sensor/switches 134, can be mounted and extend through to the user facing side of a second panel 108.

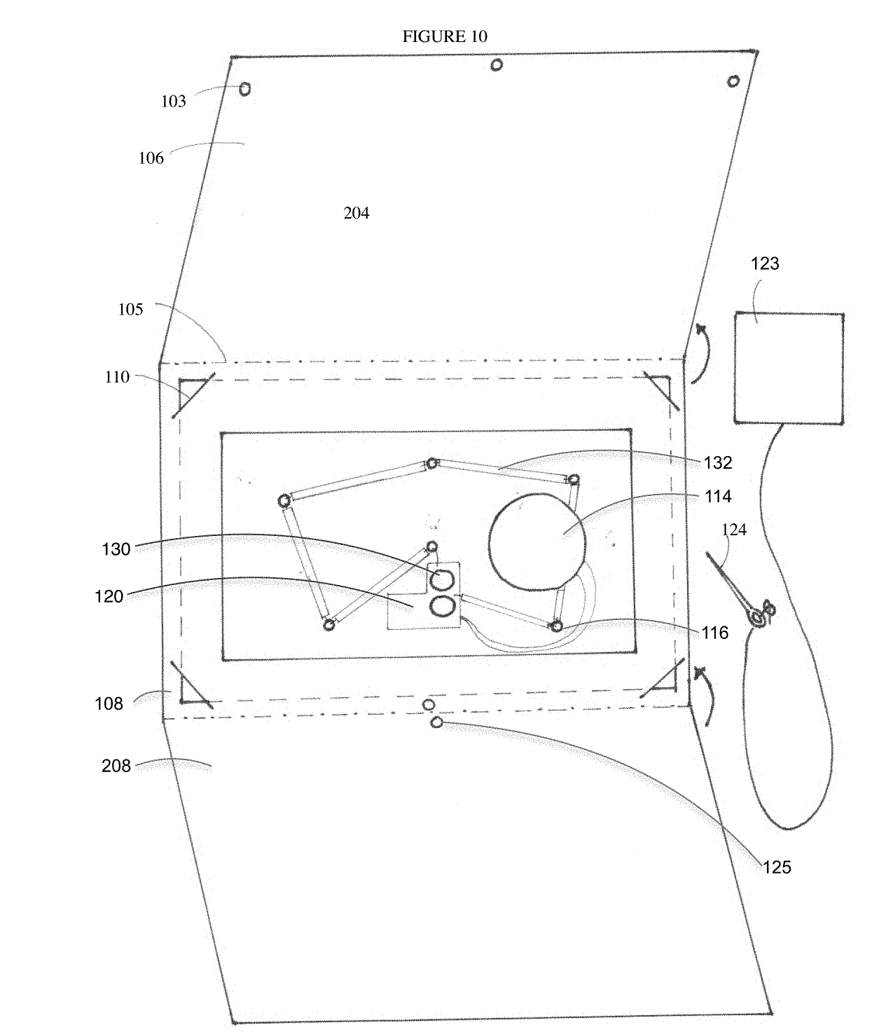

FIG. 10 illustrates an exemplary electronics aspect of a mounted display article 101 showing how the display window looks from the back exposing the electronics, and how the unfolding of the panels 106, 108 can be used to actuate the electronic components, e.g. lighting 116, sound 114, moving objects 118. FIG. 10 also shows a electronic controller 120 for the LED lights 116, electric circuit 132, and motorized objects 118 (not shown) connected to an motor housing 130, as well as a rounded speaker of the integrated recordable sound playback device 114.

The electronics may include a switch and a miniature integrated circuit (IC) having a microprocessor, memory, speaker, and battery. Both the switch and the miniature IC are embedded in the mounted display article so that they are not visible to a recipient/user. Actuating the trigger mechanism of the the mounted display article will automatically turn on or close the switch so that the IC will play pre-stored music or a recorded personal message, or both.

In further embodiments, the exemplary mounting display article 101 also includes a control module 320. The control module 320 includes an integrated circuit, an electronic circuit, a battery, a control switch, and a driver. The control module of the mounting display article 101 may also optionally include an electronic module 322. The electronic module 322 may control the sound device 114, and light display device 116.

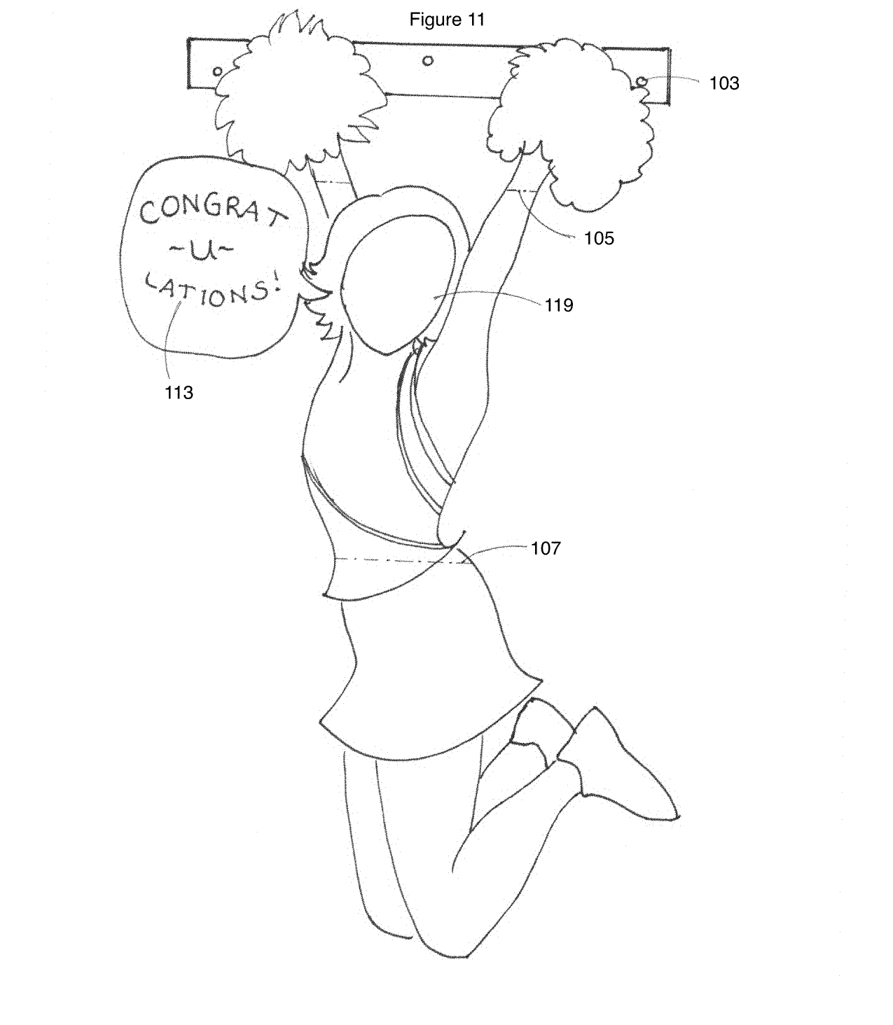

FIG. 11 illustrates a full-size embodiment of a mounted display article 101 that unfolds for a celebrant/display target and also provides a window display 119 for a user's face. FIG. 11 shows mounting means 103, first fold 105 and second fold 107, and printed indicia 113. Face display window 119 allows a user to insert their face to personalize the display and/or for photo opportunities and the like.

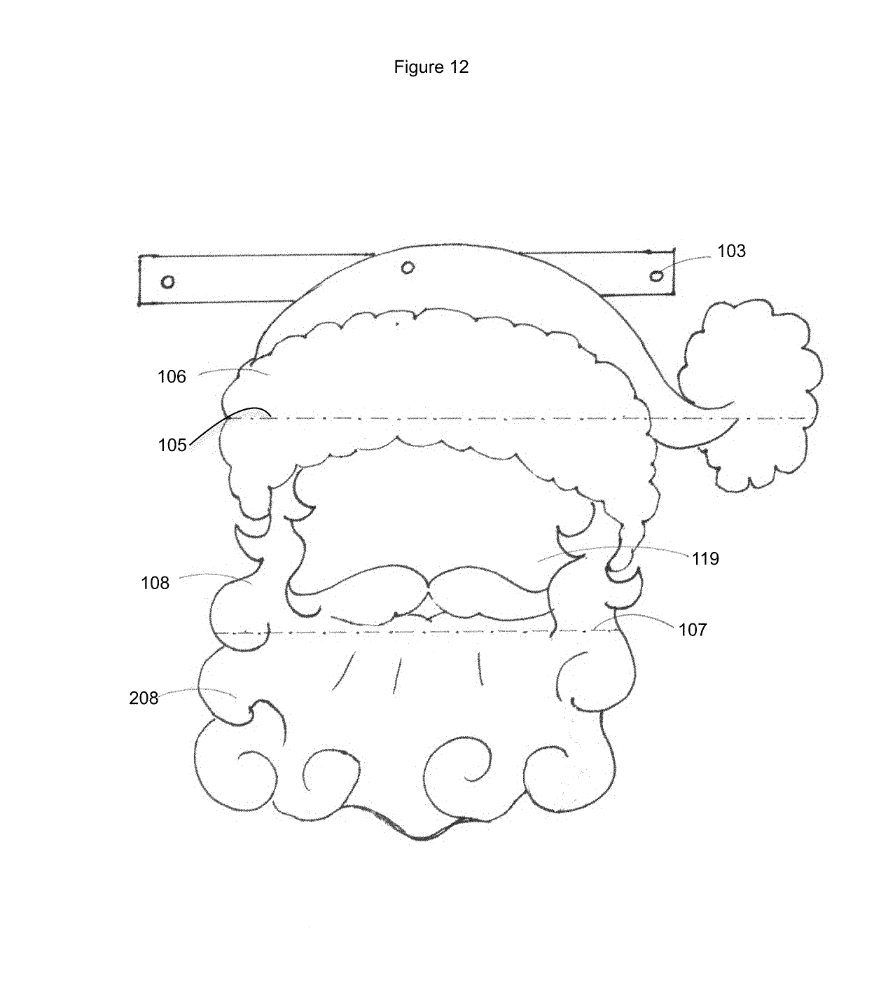

FIG. 12 illustrates a medium size embodiment of a mounted display article 101, in this case a Santa mask, with mounting means 103 where the article unfolds panels 108 and 208 away from panel 106 along folds 105 and 107 for a celebrant to see a display and also provides a window display 119 for a user's face to add to the display and/or provide photo opportunities.

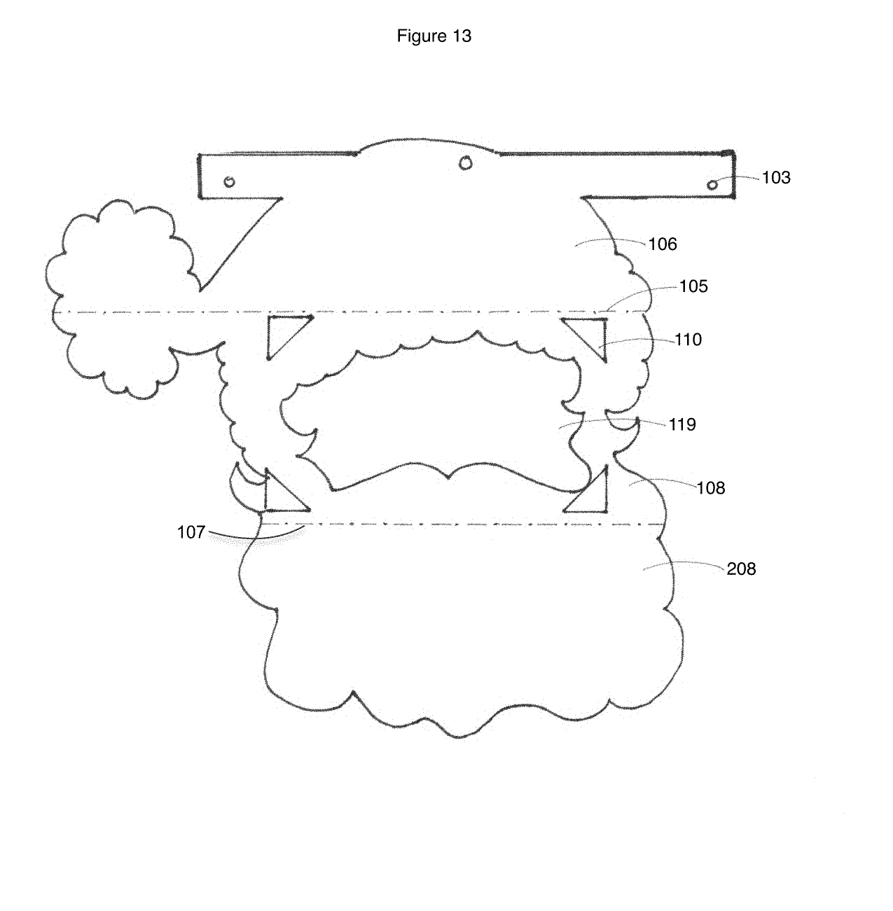

FIG. 13 illustrates a medium size embodiment of a mounted display article 101, in this case a Santa border, with mounting means 103 where the article unfolds panels 108 and 208 away from panel 106 along folds 105 and 107 for a celebrant to see a display and also provides a window display 119 with die cuts 110 in the paper board which receives a removable insert 112 (not shown).

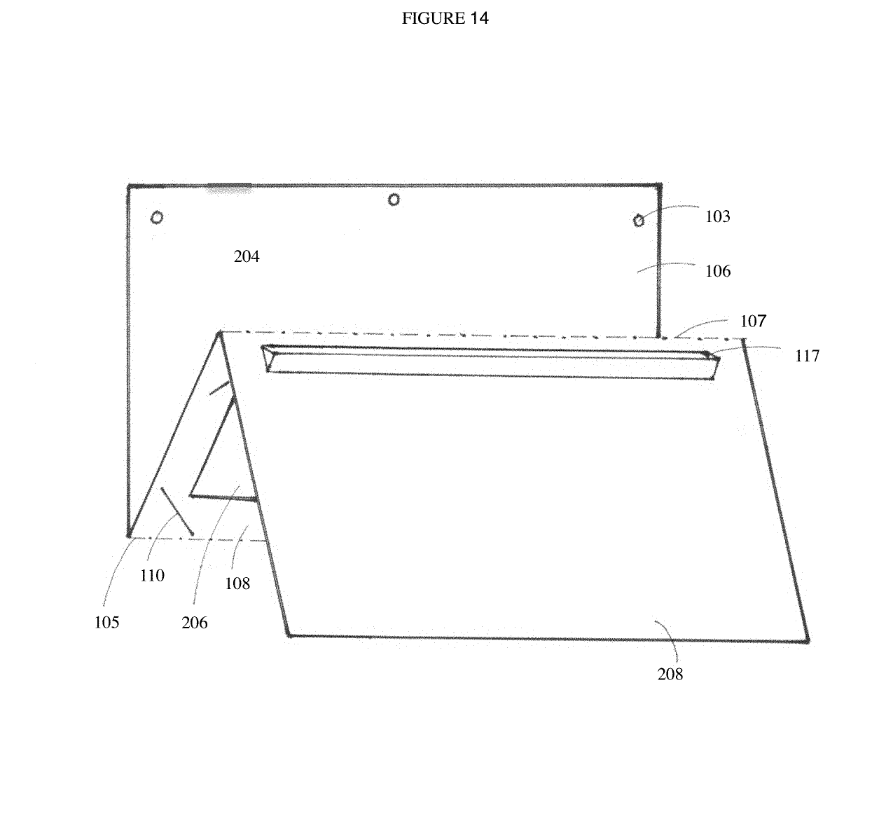

FIG. 14 is a front view of template 204 and shows a confetti/ribbon trough 117 and how the second panel 208 folds up along second fold 107 behind the template to enclose the electronics (not shown), leaving second panel 108 to unfold away from the first panel 106 along the first fold 105 and cause the display window 206 to be oriented to the front user facing view, leaving the confetti/ribbon trough 117 to empty its contents and add to the display. Mounting means 103 and die cuts 110 for mounting a removable insert are also shown.

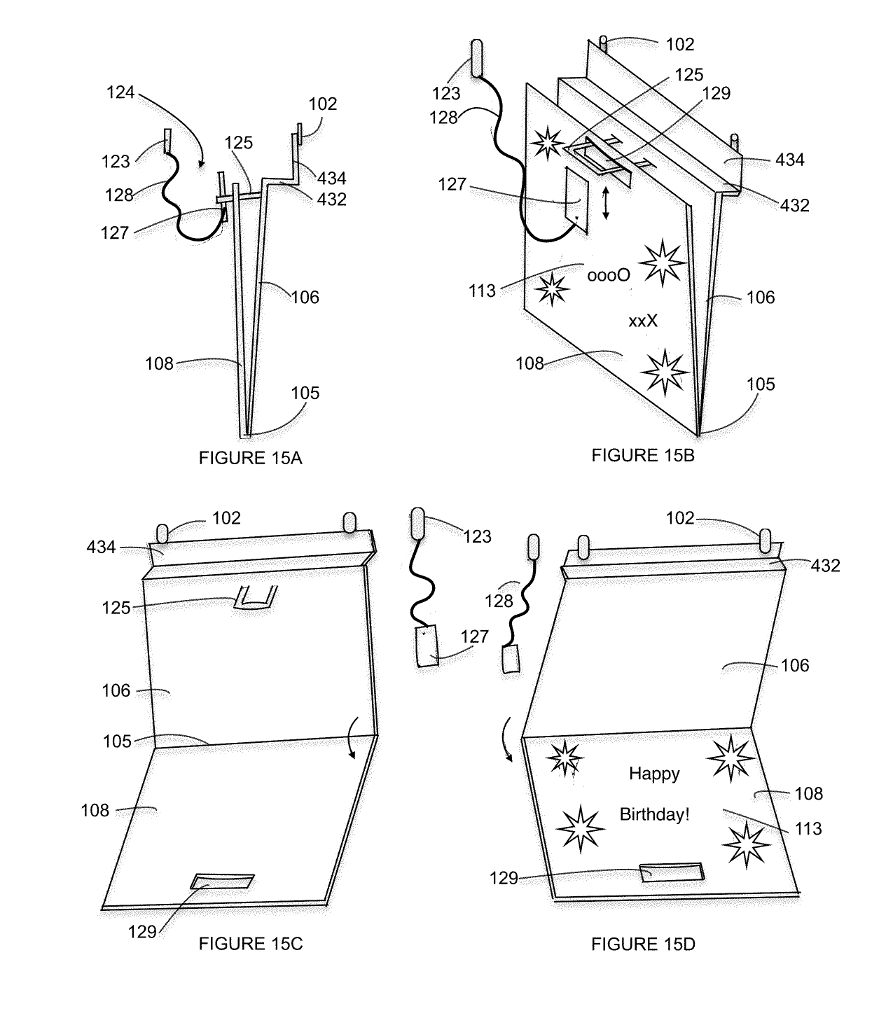

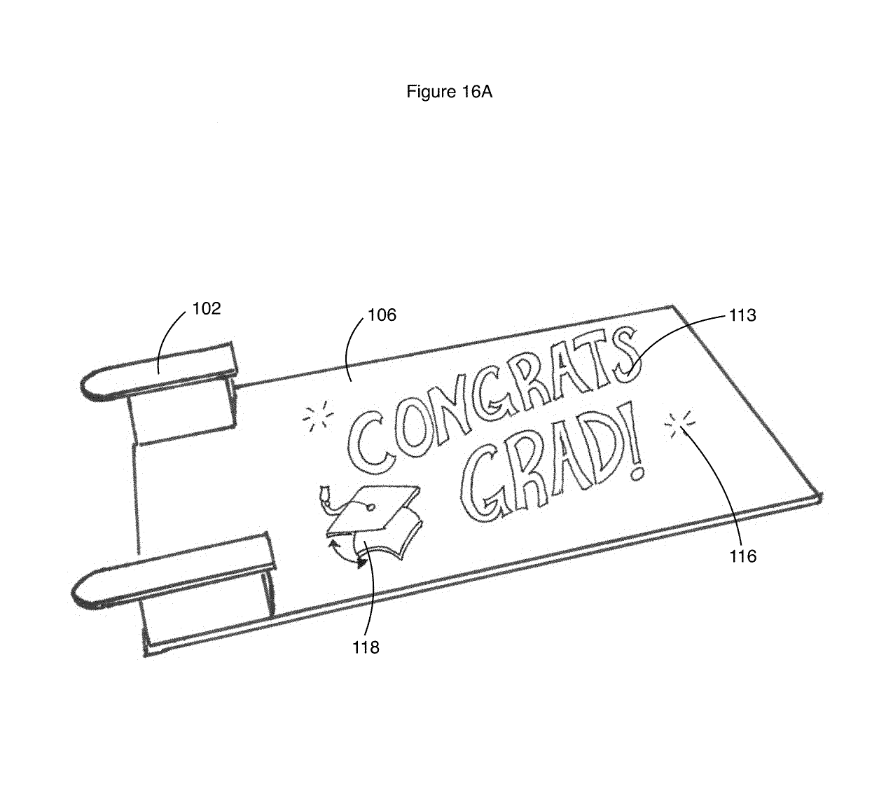

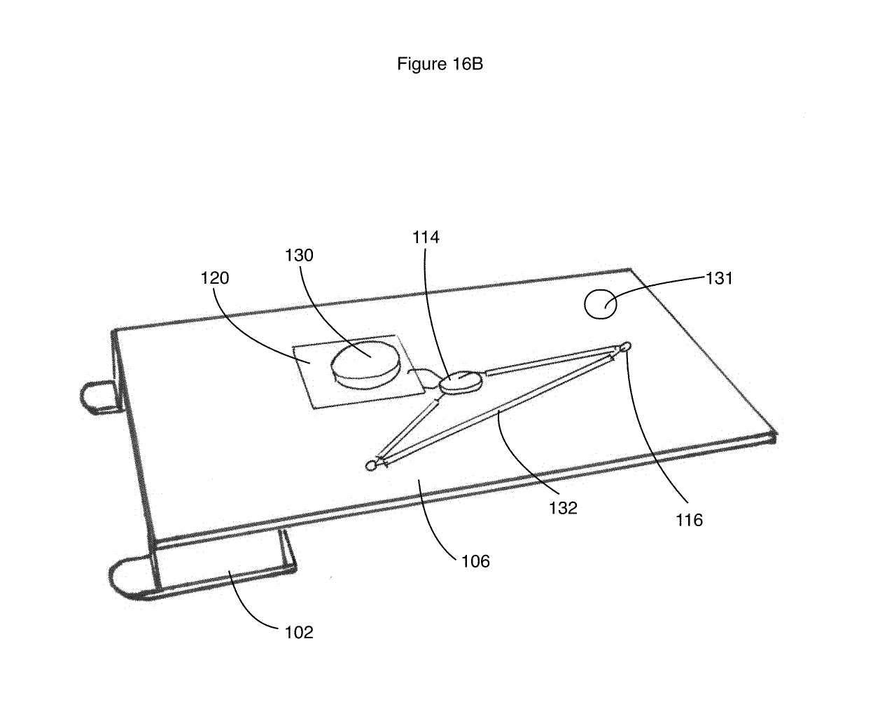

FIG. 15A, 15B, 15C, and 15D are four views of one embodiment of a display article according to the present invention. FIG. 15A is a side view of display article 101 in a two-panel version and illustrating the quick-release and/or frangible locking means 124 comprised of trigger wall mount 123 attached to trigger tether 128 which is connected to trigger pin/locking pin 127. Trigger or locking “pin” can be any shape that functions to hold panel 108 closed against panel 106 by interacting with a loop 125 or its functional equivalent. Loop 125 is connected to panel 106 and fits through loop window 129 in panel 108. When trigger pin 127 is slid into the outer gap formed when trigger loop 125 engages trigger window 129, it holds the panels 106, 108 together in a ready-position. When the pin 127 is pulled from the gap, the second panel 108 falls open and away from connected first panel 106 and displays the greeting rendered therein. When the trigger wall mount 123 is mounted on, e.g. a door, and the article 101 is mounted inside of the door on the upper doorframe, such that wall mount panel 434 is attached to the wall or doorframe and door/moulding panel 432 provides for the proper extension/positioning of the lower first and second panels 106, 108, the opening of the door causes the tether 128 to tighten and pull the pin 127, releasing the display and providing a surprise greeting/display to the person who opened the door. FIG. 15 A-D illustrates the opening of the panels and does not include the details of the LED, sound device, or motorized moving objects (included, but shown in other figures).

FIG. 16A and 16B are front and back views of a single panel embodiment of a display article. FIGS. 16A shows mounts 102 for single panel 106 having text/image indicia 113 with LEDs 116 and motorized moveable object 118. FIG. 16B shows mounts 102, panel 106, and rear-panel electronics recordable sound playback device 114, LEDs 116, circuit 132, motor housing 130, electronic control 120, and motion sensor (or remote control sensor) 131.

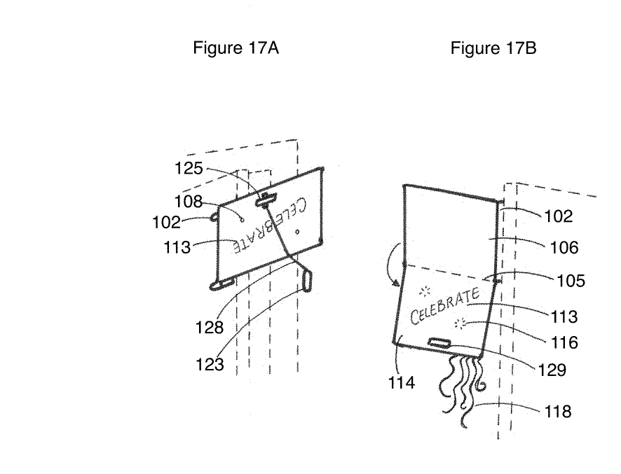

FIG. 17A and 17B are before and after views of a two-panel door-mounted embodiment of a display article. FIG. 17A shows loop 125 extending through second panel 108 which has text/image indicia 113. Mounts 102 are attached to first panel 106 (not shown in 17A). Trigger wall mount 123 connect tether 128 in order to pull the pin out of loop 125 when the door is opened. FIG. 17B shows mount 102 on first panel 106, connected by fold 105 to second panel 108 having indicia 113, LEDs 116, and motorized moving object 118. Loop window 129 was operably connected to loop 125 when the panels 106 and 108 are fold-back upon themselves before the pin (not shown) was disengaged. Recordable sound playback device 114 broadcasts through panel 108, but the housing is behind panel 108.

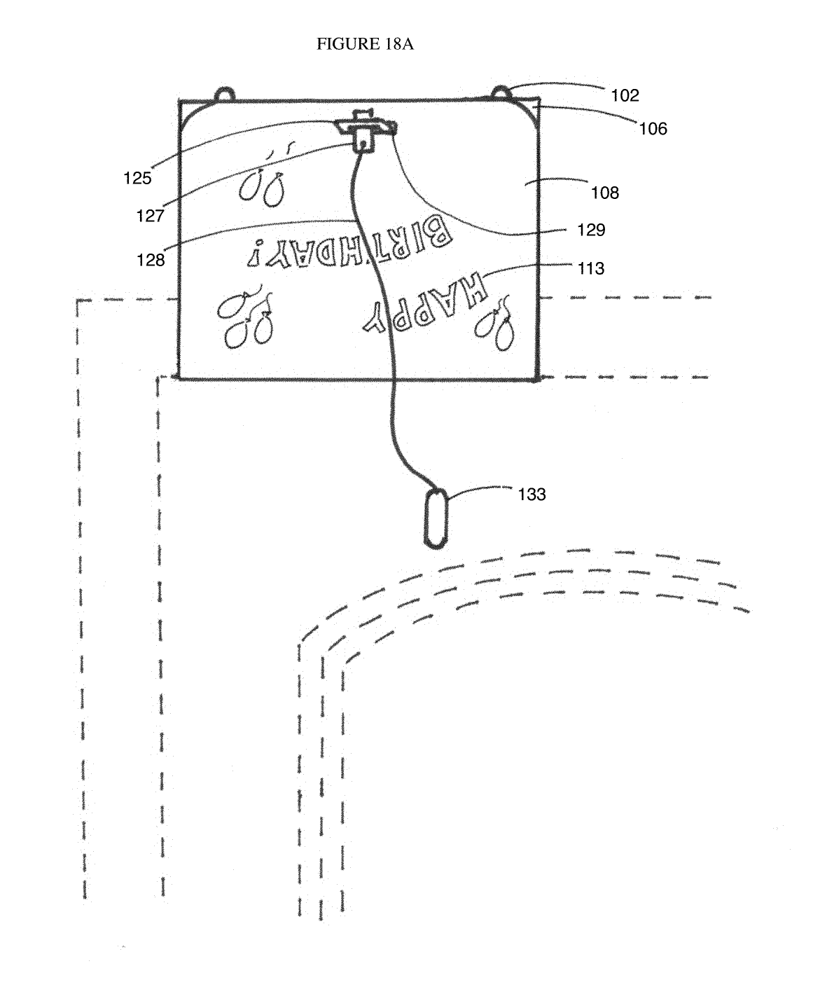

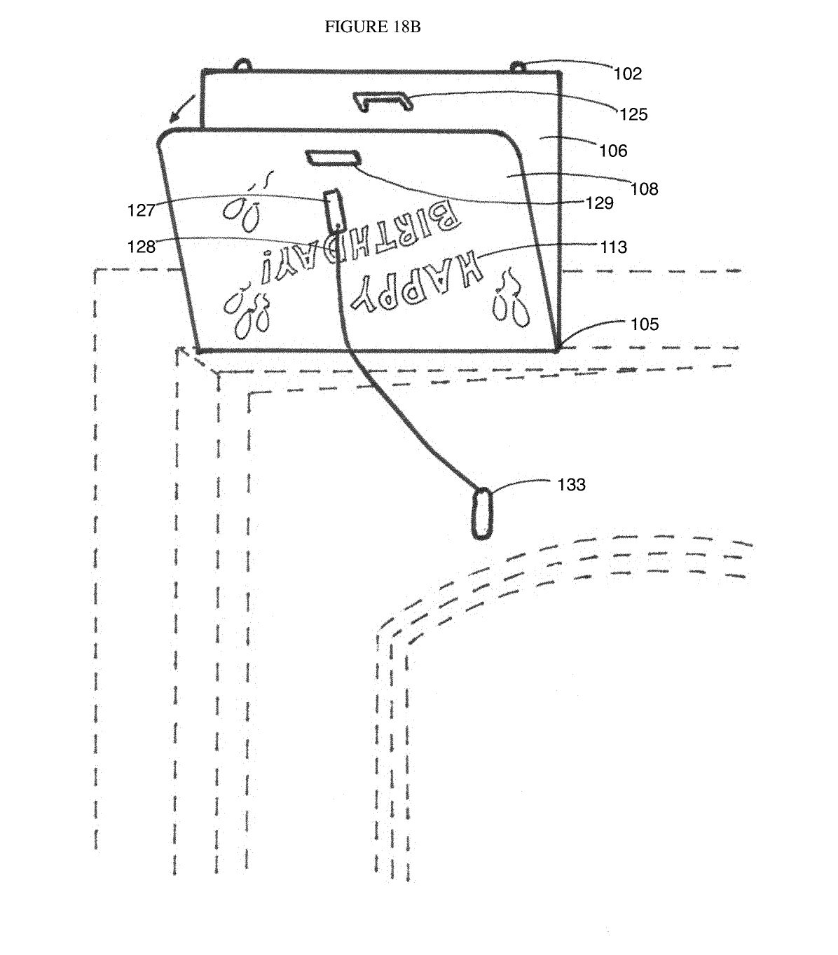

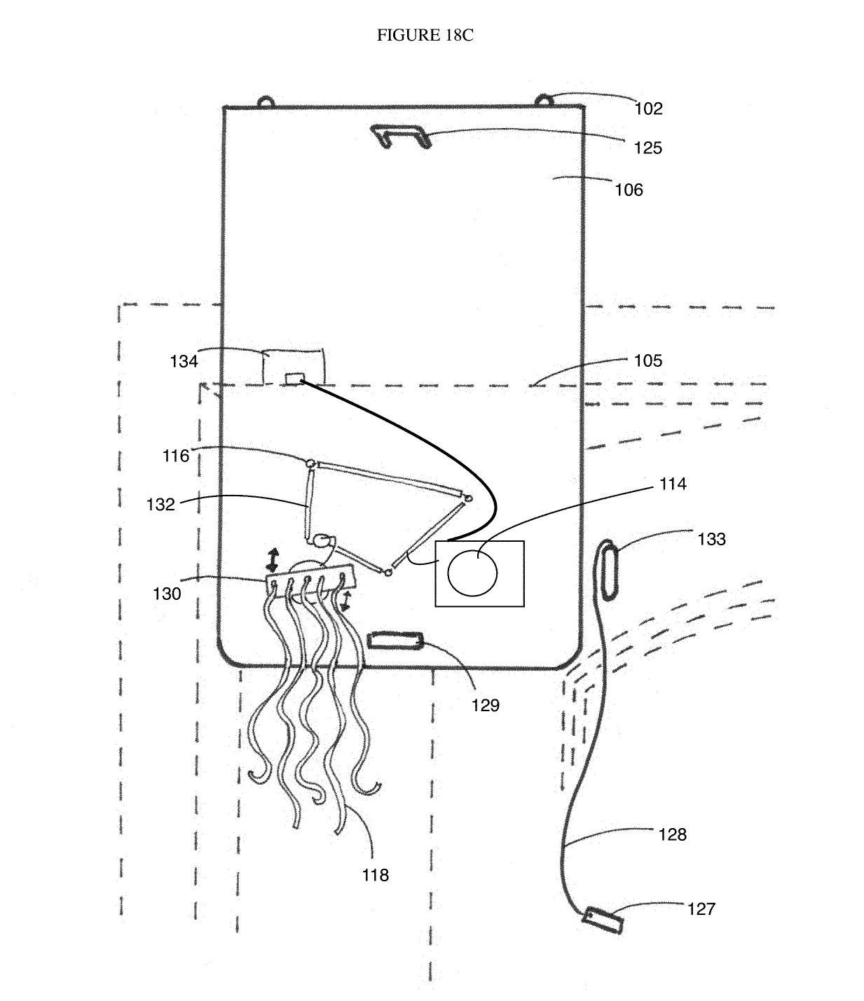

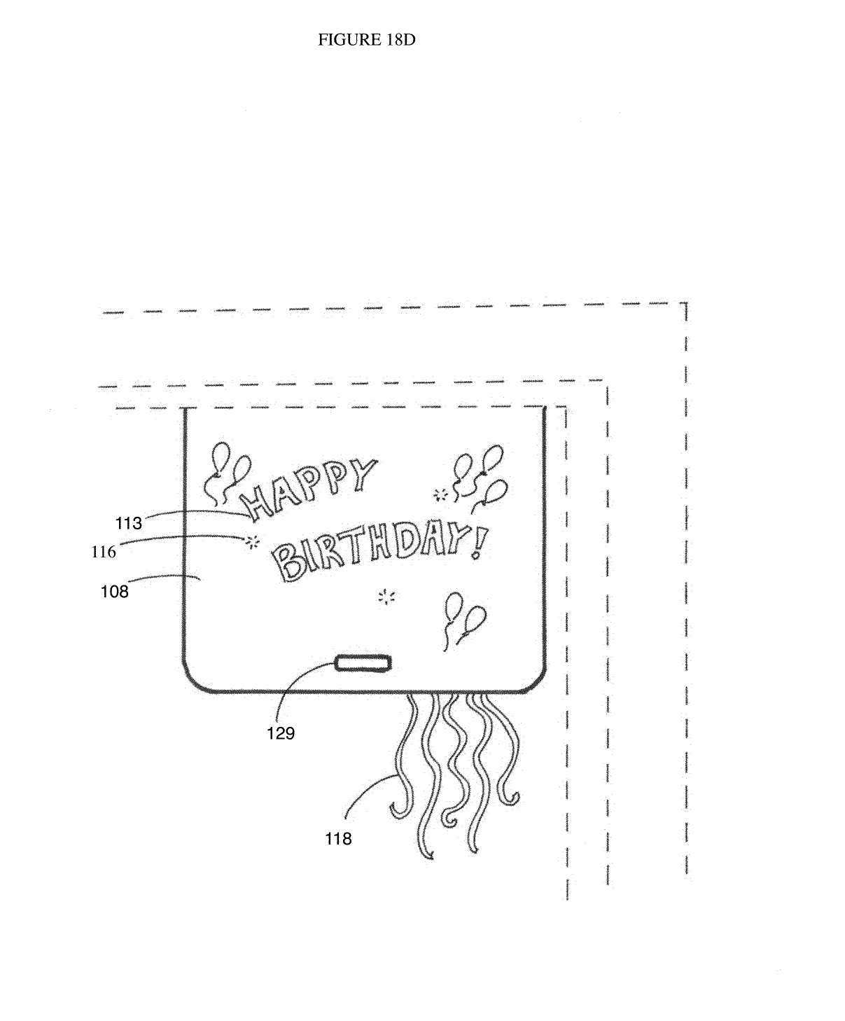

FIG. 18A, 18B, 18C, and 18D are four views of one embodiment of a display article mounted above a door frame and starting from a locked or closed position in 18A illustrates how it opens and is then viewed by the target of the greeting in FIG. 18D.

FIG. 18A shows mount 102 attaching panel 106 to a wall (not a door). Pin 127 attached by tether 128 is connected to door mount 133. Loop 125 attached to panel 106 extends through loop window 129 cut out of second panel 108. Second panel 108 has indicia 113 that will be visible to the celebrant when the article unfolds.

FIG. 18B shows mount 102 attaching panel 106 to a wall (not a door). Pin 127 attached by tether 128 is connected to door mount 133. Second panel 108 begins to fall open as the opening of the door causes the tether 128 to tighten pulling pin 127 out of its ready position (inserted into loop 125). Loop 125 attached to panel 106 has disengaged from loop window 129 cut out of second panel 108. Second panel 108 has indicia 113 that will be visible to the celebrant when the article unfolds along fold 105.

FIG. 18C shows mount 102 attaching panel 106 to a wall (not a door). Panel 108 has fully extended away from panel 106 and has actuated motion sensor/switch 134. Switch 134, connected by circuit 132, then triggers LEDs 116, motorized moveable object 118 connected to the motor housing 130, and recordable sound playback device 114. Door mount 133 is shown dangling tether 128 and pin 127.

FIG. 18D shows the “front” celebrant side of panel 108 having festive indicia 113, LEDs 116, moving objects 118. FIG. 18D also shows loop window 129 that was used to lock panel 106 against second panel 108, and actuate the switch 134. Where an electronic switch or remote is used to actuate the LEDs, sound, and moving objects, the pin and tether mechanism is used mainly as a quick-release frangible locking means. Although it is also within the scope of the invention that the pin and tether could be used to actuate one feature while secondary features are activated using another means, e.g. switch.

### PARTS LIST

(101) mounted display article
(102) mounting device
(103) mounting holes
(104) multi-panel bulletin display article
(105) first fold
(106) first panel
(107) second fold
(108) second panel
(110) die-cuts
(111) brackets for holding insert
(112) removable insert
(113) printed indicia having an event or holiday theme
(114) recordable sound playback device
(115) protective sleeve
(116) lighting display
(117) container for confetti
(118) motorized moveable objects
(119) window display for user's face
(120) electronic control
(122) trigger mechanism
(123) trigger/pin wall mount
(124) a pin and tether device
(125) pin receiver/loop
(126) rolled-up object
(127) pin/locking pin
(128) tether
(129) loop window
(130) motor housing
(131) electronic/motion sensor
(132) circuit
(133) door mount
(134) motion-sensor switch/trigger
(204) multi-panel bulletin board template
(205) mounting pads
(206) display window
(207) hooks 103
(208) third panel
(210) mounting windows
(432) door/moulding panel
(434) wall mount panel

The motorized movable object or objects include waving or dancing figures, spinning objects, objects that move back and forth, representational and purely graphic visual objects. A mechanical actuator is attached to the second panel and uses standard input gearing, axles, cams, switches, springs, and cranks to facilitate the mechanical movement. The IC microprocessor can control and coordinate the playback sound with the object movement to achieve a synchronized message/display.

Trigger mechanisms include pin and tether trigger devices, light-sensor trigger devices, and motion-sensor trigger devices. Trigger devices can also be push-button, remote-control, touch or pressure sensitive switches, contact switches, and the like.

An important aspect is that article is pre-triggered and passively actuated by or for a target celebrant, and is not directly, intentionally actuated by the celebrant user. This article is designed so that the opening of a door, or the triggering of a sensor, by a unsuspecting celebrant/user is what causes the panels to actuate the LEDs, sound, and moving objects. Another aspect is, in reference to the multi-panel embodiments, is that the panels unfold due to gravitational forces. Thus, in some embodiments, the (first) triggering, e.g. door or motion, causes the panels to (passively) unfold, and the unfolding of the panels is a secondary trigger to actuate the electronics, i.e. LEDs, sound, and moving objects.

Another important aspect is that the display article can be reuseable where the removable insert is swapped out for subsequent uses depending on the occasion. For example, the one-, two- or three-panel embodiment can be used over and over to mount various inserts, such as a birthday greeting insert, a graduation insert, a holiday insert, a wedding insert, a new baby insert, a new job or new home insert, or any other type of greeting where a celebrant is targeted for a surprise greeting.

### EQUIVALENTS

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

1. A mounted display article, comprising:
a multi-panel bulletin display having a first panel and a second panel;
a mounting device that removably attaches to a proximal edge of the first panel of the multi-panel bulletin display;
a removable greeting card insert;
the second panel of the multi-panel bulletin device connected to a distal edge of the first panel with a foldable binding, the second panel having die-cuts for receiving the removable greeting card insert;
a pin and tether release mechanism comprising a loop attached to the first panel, a loop window within the second panel configured to receive the loop, a pin connected by a tether to a trigger mount, the pin configured in a first position to fit within the loop and hold the first panel and second panel in a folded position when the trigger mount is within tether length of the loop, the pin configured in a second position to pull out of the loop and release the first panel and second panel in an unfolded position when the trigger mount is moved and tightens the tether to pull the pin from the loop;
the removable greeting card insert comprising printed matter, a sound playback device, a light display, and a motorized movable object, wherein the sound playback device, the light display, and the motorized movable object are connected in a circuit to a trigger mechanism;
the trigger mechanism connected to the foldable binding between the first panel and the second panel and activated by the second panel unfolding along the foldable binding from a folded position to an unfolded position, wherein the activated trigger mechanism triggers the sound playback device to play a pre-recorded message, wherein the activated trigger mechanism triggers the light display, and wherein the activated trigger mechanism triggers the motorized movable object.

2-6. (canceled)

7. (canceled)

8. The mounted display article of claim 1, wherein the printed matter and the sound playback device have an event or holiday theme.

9. The mounted display article of claim 1, wherein the first panel and the second panel comprise a single folded sheet of material.

10. A method of displaying a multi-panel bulletin, comprising the steps of:
Mounting a multi-panel bulletin display to a wall or doorframe using a mounting device, the mounting device is removably attached to a proximal edge of a first panel of the multi-panel bulletin display, a second panel of the multi-panel bulletin device connected to a distal edge of the first panel with a foldable binding, a pin and tether release mechanism comprising a loop attached to the first panel, a loop window within the second panel configured to receive the loop, a pin connected by a tether to a trigger mount, the pin configured in a first position to fit within the loop and hold the first panel and second panel in a folded position when the trigger mount is within tether length of the loop, the pin configured in a second position to pull out of the loop and release the first panel and second panel in an unfolded position when the trigger mount is moved and tightens the tether to pull the pin from the loop; a removable greeting card insert mounted in the second panel, the second panel having die-cuts for receiving the removable greeting card insert, the removable greeting card insert comprising printed matter, a sound playback device, a light display, and a motorized movable object, wherein the sound playback device, the light display, and the motorized movable object are connected in a circuit to a trigger mechanism; and,
Releasing the second panel to unfold along the foldable binding by causing the pin to be pulled from the loop, and wherein the second panel unfolding along the foldable binding triggers the sound playback device to play a pre-recorded message, triggers the light display, and triggers the motorized movable object.

11-14. (canceled)

15. (canceled)

16. The method of claim 10, wherein the printed matter and the sound playback device have an event or holiday theme.

17. The method of claim 10, wherein the first panel and the second panel comprise a single folded sheet of material.

18. (canceled)
